(19) United States
(12) Patent Application Publication
(10) Pub. No.: US 2020/0180281 A1
(43) Pub. Date: Jun. 11, 2020

(54) VACUUM SKIN PACKAGES FOR SOFT PRODUCTS AND VACUUM SKIN METHOD OF PACKAGING

(71) Applicant: Cryovac, LLC, Charlotte, NC (US)

(72) Inventor: Maurizio Ciocca, Novara (IT)

(21) Appl. No.: 16/620,562

(22) PCT Filed: Jun. 21, 2018
(86) PCT No.: PCT/EP2018/066687

§ 371 Date: Dec. 9, 2019

(30) Foreign Application Priority Data
Jun. 30, 2017 (EP) 17179218.7

(51) Int. Cl. B32B 27/08; B32B 27/34; B32B 27/30; B32B 27/36; B32B 27/32; B32B 7/12; B65D 65/40; B65D 81/20

(52) U.S. Cl. CPC B32B 27/08; B32B 2307/704; B32B 27/304; B32B 27/306; B32B 27/36; B32B 27/32; B32B 27/308; B32B 7/12; B65D 65/40; B65D 81/2007; B32B 2439/70; B32B 2307/51; B32B 2307/54; B32B 2307/7244; B32B 2250/24; B32B 2307/306; B32B 27/34

(57) ABSTRACT

The present invention relates to the use of multilayer films of certain modulus, thickness and composition for vacuum skin packaging soft products such as, for instance, minced meat and to the packages so obtained. Advantageously, the VSP packages of the invention keep hermeticity and have a pleasant appearance.

### TECHNICAL FIELD

The present invention relates to multilayer films useful in vacuum skin packaging of soft products and to vacuum skin packages manufactured therefrom.

### BACKGROUND ART

Vacuum skin packaging (VSP) is a process well known in the art using a thermoplastic packaging material to enclose a food product. The vacuum skin packaging process is in one sense a type of thermoforming process in which an article to be packaged serves as the mould for a forming web. An article may be placed on a rigid or semi-rigid support member, that can be flat or shaped, e.g., tray-shaped, bowl-shaped or cup-shaped (called “bottom” web), and the supported article is then passed to a chamber where a “top” web is first drawn upward against a heated dome and then draped down over the article. The movement of the top web is controlled by vacuum and/or air pressure, and in a vacuum skin packaging arrangement, the interior of the container is vacuumed before final welding of the top web to the bottom web.

The distinguishing feature of a vacuum skin package is that the upper heated film forms a tight skin around the product and is sealed to the part of the support not covered by the product.

The terms “vacuum skin packaging” or “VSP” as used herein indicate that the product is packaged under vacuum and the space containing the product is evacuated from gases at packaging. The top flexible film draped over the product is referred to as “skin-forming” or “skin” film or simply “top film”.

Vacuum skin packaging is described in many references, including FR1258357, FR1286018, AU3491504, U.S.RE30009, U.S. Pat. Nos. 3,574,642, 3,681,092, 3,713,849, 4,055,672 and 5,346,735.

Vacuum skin packaging has become an increasingly attractive way of packaging several kinds of food, in particular fresh red meats. The final package presents a tight fitting, clear package which protects the food article from the external environment.

However, the demands imposed on the packaging material used in vacuum skin packaging are particularly high, especially during the heating phase in the dome and the subsequent draping over the product.

Films suitable for VSP applications, for example, have to stand the heating and stretching conditions within the vacuum chamber of the packaging machine without undergoing excessive softening and perforations.

Other important mechanical features of VSP films are machinability and formability. Product typically packaged in vacuum skin packages are for instance fresh meat, poultry, fish, seafood, vegetables, ready meals or frozen products (such as meat, vegetables, ready meals or fish).

Vacuum skin packaging of soft food products is a long felt need in the packaging industry. The term “soft products” as used herein refers to food products that are easily formed into any shape and are deformable under very low forces, such as those applied by a person's hand or by any type of kitchen tool. These soft products, like minced meat, ground meat, meat or fish hamburgers, caviar, sausages, sliced meat, sliced fish, sliced processed meat, diced meat, meat or fish tartare, pate, soft cheese, mashed vegetables, diced vegetables, mashed fruit, diced fruit, fresh dough, fresh fish, sauces, bread, pizza, pastries, fresh pasta and cooked pasta are soft and their vacuum skin packaging can be troublesome because the soft product does not hold a predetermined shape if subjected to any force or pressure. This can result in the soft product being completely squeezed by the skin film at the end of the packaging cycle.

Because of the deformation of the product, package appearance has never been considered acceptable, as the product presentation was not as appealing as that of a more firm meat product, such as beefsteaks or pork chops. Moreover, there are two additional negative effects of the squeezing of the products: the contamination of the sealing area around the product resulting in a risk of lack of hermeticity of the package and the possible contamination of the VSP equipment thus resulting in an inefficient, unsafe and economically disadvantageous process.

There have been several different approaches in the past with the aim to solve the above problems. A first attempt to package a soft product under vacuum skin packaging conditions has been to reduce the thickness of the standard top films in order to exert less pressure on the product to be packaged.

The issue with conventional VSP formulations, when used in low thicknesses, is their poor machinability, which negatively affect productivity. In fact, in a standard VSP process, when a conventional top web is unwind from the roll at high speed, it tends to neck-in under the tension applied, namely it tends to elongate in longitudinal direction and to reduce its width: as a consequence the narrowed film is no more correctly pinched by the trailing chains, thus leading to malfunctioning of the system and, unavoidably, to interruptions in VSP cycle.

Additionally conventional too thin VSP films may encounter other drawbacks, such as in-line breakings, especially when the equipment is restarted after occasional stops.

Another attempt to obtain VSP package of soft products has been to “crust freezing” the products before packaging. Typically, a process of crust freezing is done by passing the product into special cold rooms that only cool the outside of the product. However, there are disadvantages linked to this additional step. First, the product might no longer be classified as “fresh product” and this is particularly undesirable for meat. Furthermore, there are additional costs associated with the refrigerating step and for the other means required to ensure hygiene and food safety. Additionally, production yield is negatively affected. Finally, as the product becomes more rigid after the freezing step, top films having a higher thickness must be used to withstand the VSP cycle onto harder products without breaking.

Overall, the additional step reduces the process and production chain sustainability. As a result, in the Applicant's knowledge, vacuum skin packages of soft products, in particular of fresh minced meat, are not currently available on the market.

Good forming ability is highly desirable in VSP applications to ensure that the heated film adequately conforms to the shape of the packaged product, without leaving pleats on the package surfaces or without forming protruding areas of self-adhesion of the film, at the package corners or sides. This unwanted phenomenon, known as bridging or webbing, can be so marked to involve separate forming units in the same packaging operation. Obviously, packages showing these defects in the top skin draping are not acceptable for the consumer and therefore they have to be rejected. Other important features of VSP films include oxygen barrier properties, for the preservation of food product such as meats adversely affected by oxidation, and optical properties, such as glossiness and haze, which contribute to an attractive package appearance.

In VSP applications, polyamides have been used very rarely as components of the top web and mainly for their barrier properties, as the only gas barrier layer as in EP1746046 or as a barrier reinforcement, flanking a central gas barrier layer of EVOH as described in U.S. Pat. No. 5,491,009 or in EP2386411A1. In all these documents, there is neither mention to the problem of vacuum skin packaging soft products nor any example of soft products vacuum skin packaged. In fact, the food products packaged therein are semi-hard cheese, cuts of meat or hard, sharp products such as bone-in meat, crustaceans and shellfish.

The document WO2011138320A1, in the name of Cryovac, describes VSP packages for unspecified products. The only packages therein exemplified (par. 166) comprise “hard” products, in particular plastic blocks. The document EP1398149A1, in the name of Cryovac, describes laminates with a modulus at 23° C. of at least 4000 Kg/cm² for use as top webs in VSP packaging of unspecified products.

In conclusion, there is still the need to provide VSP packages of soft products, which guarantee an airtight and uncontaminated closure and, additionally, have a pleasant appearance for the customer.

### SUMMARY OF THE INVENTION

It has now been found that by selecting certain films characterized by a peculiar combination of thickness and modulus, said films preferably comprising at least one inner layer of a polyamide as top webs, it is possible to package soft product in conventional vacuum skin process without squeezing the packaged tender product and without jeopardizing the package hermeticity.

The top webs suitable for this specific packaging application are highly formable and perfectly conform, without squeezing, to the soft products. Furthermore, they are highly resistant to implosion and do not break during the vacuum skin packaging process.

Accordingly, it is a first object of the present invention a vacuum skin package comprising a support, a soft product loaded onto said support and a top web draped over the product and welded to the part of the support not covered by the soft product,

wherein the top web is a multilayer film, comprising at least an outer sealing layer a) and an outer abuse layer b), and wherein said multilayer film has an elastic modulus in LD of at least 3800 Kg/cm² measured at 23° C. according to ASTM D 882 and a total thickness lower than 100 microns.

Preferably, the top web multilayer film further comprises at least an inner polyamide layer f) in a percentage thickness ratio to the total thickness of the film of at least 3% and of at most 30%.

A second object of the present invention is a vacuum skin packaging process, for the manufacture of a vacuum skin package of a soft product, which comprises:
providing a top web,
providing a support,
disposing the top web over the support,
disposing the soft product onto the support,
heating the top web and moulding it down upon and around the soft product and against the support, the space between the heated top web and the support having been evacuated, to form a tight skin around the soft product, and
tight sealing said top web over the entire surface of the support not covered by the product by differential air pressure, thus providing a vacuum skin package, wherein the top web is a multilayer film comprising at least an outer sealing layer a) and an outer abuse layer b),
in which said multilayer film has an elastic modulus in LD of at least 3800 Kg/cm² measured at 23° C. according to ASTM D 882 and a total thickness lower than 100 microns.

Preferably, the top web multilayer film further comprises at least an inner polyamide layer f) in a percentage thickness ratio to the total thickness of the film of at least 3% and of at most 30%.

A third object of the present invention is the use of a multilayer film comprising at least an outer sealing layer a) and an outer abuse layer b), as top web for vacuum skin packaging soft products, wherein the film has an elastic modulus in LD of at least 3800 Kg/cm² measured at 23° C. according to ASTM D 882 and a total thickness lower than 100 microns.

Preferably, the top web multilayer film further comprises at least an inner polyamide layer f) in a percentage thickness ratio to the total thickness of the film of at least 3% and of at most 30%.

### BRIEF DESCRIPTION OF THE DRAWINGS

FIGS. 1, 2 and 3 show a scheme of the sealing defects that may occur in a VSP packaging cycle, their denomination and score in the present formability test.

FIG. 4 is a schematic top view of the block used in the present implosion resistance test. The drawing is on scale.

FIG. 5 shows two pictures of fresh minced meat vacuum skin packaged with the comparative film C2 (FIG. 5A), showing the smashed meat, or with the film 1 suitable for the present use, with a preserved minced meat (FIG. 5B).

### DEFINITIONS

As used herein, the term “soft product” refers to food and non-food products that are easily formed into any shape and are deformable with very little force, such as with a person's hand or any type of tool. Examples of soft food products include minced meat, ground meat, meat or fish hamburgers, caviar, sausages, sliced meat, sliced fish, sliced processed meat, diced meat, meat or fish tartare, pate, soft cheese, mashed vegetables, diced vegetables, mashed fruit, diced fruit, fresh dough, fresh fish, sauces, bread, pizza, pastries, fresh pasta and cooked pasta.

As used herein, the term “core”, and the phrase “multilayer core”, as applied to the multilayer film refers to any internal film layer or multiple internal film layers that has a primary function other than serving as an adhesive for adhering two layers to one another.

As used herein, the term “tie layer” refers to any internal layer having the primary purpose of adhering two layers to one another.

As used herein, the phrase “outer layer” in connection with the multi-layer film refers to a layer having only one of its principal surfaces directly adhered to another layer of the film.

As used herein “sealing layer” or “sealant layer” is the outer layer of the multi-layer film that in the VSP packaging process will be in contact with the food product and will seal to the support, while “abuse or skin layer” will be the outer layer that in the VSP packaging process will be in contact with the heated dome.

As used herein, the phrase “inner layer” in connection with the multi-layer film refers to a layer having both its surfaces adhered to other layers of the film

As used herein the term “directly adhered” as applied to the layers of a multi-layer film, refers to the adhesion of a first element to a second element, without an adhesive, a tie layer or any other layer there between. In contrast, as used herein, the word “adhered” when used without the adverb “directly”, broadly refers to the adhesion of a first element to a second element either with or without an adhesive, a tie layer or any other layer there between.

As used herein the term “bulk layer” or “structural” layer refers to a layer generally used to improve the abuse or puncture resistance of the film or just to provide the desired thickness.

As used herein the term “polyolefin” refers to any polymerized or co-polymerized olefin that can be linear, branched, or cyclic, substituted or unsubstituted, and possibly modified. Resins such as polyethylene, ethylene-alpha-(C4-C8)olefin copolymers, ethylene-propylene copolymers, ethylene-propylene-alpha-(C4-C8)olefin ter-polymers, propylene-butene copolymer, polybutene, poly(4-methyl-pentene-1), ethylene-propylene rubber, butyl rubber, as well as copolymers of ethylene (or a higher olefin) with a comonomer which is not an olefin and in which the ethylene (or higher olefin) monomer predominates such as ethylene-vinyl acetate copolymers, ethylene-acrylic acid copolymers, ethylene-alkyl acrylate copolymers, ethylene-methacrylic acid copolymers, ethylene-alkyl methacrylate copolymers, ethylene-alkyl acrylate-maleic anhydride copolymers, ionomers, as well the blends thereof in any proportions are all included. Also included are the modified polyolefins, where the term “modified” is intended to refer to the presence of polar groups in the polymer backbone. The above polyolefin resins can be “heterogeneous” or “homogeneous”, wherein these terms refer to the catalysis conditions employed and as a consequence thereof to the particular distribution of the molecular weight, branched chains size and distribution along the polymer backbone, as known in the art.

As used herein the term “ethylene-alpha-(C4-C8)olefin copolymers” is intended to refer to both heterogeneous and homogeneous (e.g., “single site”, or “metallocene”) materials with densities of from about 0.86 to about 0.95 g/cm3.

Ethylene homopolymers include high density polyethylene (HDPE) and low density polyethylene (LDPE).

The term “ethylene copolymer” is used herein to refer to ethylene/alpha-olefin copolymers. Ethylene/alpha-olefin copolymers generally include copolymers of ethylene and one or more comonomers selected from alpha-olefins having from 4 to 12 carbon atoms, such as 1-butene, 1-pentene, 1-hexene, 1-octene, 4-methyl-1-pentene and the like.

The term linear low density polyethylene (LLDPE) is generally understood to include that group of ethylene/alpha-olefin copolymers which fall into the density range of about 0.915 to about 0.94 g/cm3 and particularly about 0.915 to about 0.925 g/cm3. Sometimes linear polyethylene in the density range from about 0.926 to about 0.94 g/cm3 is referred to as linear medium density polyethylene (LMDPE). Lower density ethylene/alpha-olefin copolymers may be referred to as very low density polyethylene (VLDPE) and ultra-low density polyethylene (ULDPE). Ethylene/alpha-olefin copolymers may be obtained by either heterogeneous or homogeneous polymerization processes.

Medium density polyethylene (MDPE) is generally considered to have a density range of 0.926 to 0.940 g/cc and a relatively low degree of branching and High density polyethylene (HDPE) is generally considered to have a density of greater than or equal to 0.941 g/cc and a relatively low degree of branching), more preferably HDPE.

As used herein the term “ionomer” designates metal salts of acidic copolymers, such as metal salts of ethylene/acrylic acid copolymers or metal salts of ethylene/methacrylic acid copolymers, wherein the neutralizing cation can be any suitable metal ion, e.g. an alkali metal ion, a zinc ion, or other multivalent metal ions. These are available, for instance, from DuPont under the trade name Surlyn.

As used herein the term “gas barrier layer ” refers in general to a gas barrier layer or, preferably, to an oxygen-barrier layer, and it is used to identify layers or structures characterized by an Oxygen Transmission Rate (evaluated at 23° C. and 0% R.H. according to ASTM D-3985) of less than 500 cm3 m2·day·atm. Suitable thermoplastic materials that would provide such gas-barrier properties are PVDC, polyamides, EVOH, polyesters, and blends thereof, preferably EVOH.

As used herein, the term “EVOH” includes saponified or hydrolyzed ethylene-vinyl acetate copolymers, and refers to vinyl alcohol copolymers having an ethylene comonomer content typically comprised between about 20 and about 60 mole %, preferably comprised from about 25 to about 48 mole %, more preferably from about 32 to about 48 mole % and even more preferably, from about 38 to about 44 mole %, and a saponification degree of at least 85%, preferably at least 90%, more preferably higher than 95%.

PVDC is any vinylidene chloride copolymer wherein a major amount of the copolymer comprises vinylidene chloride and a minor amount of the copolymer comprises one or more unsaturated monomers copolymerisable therewith, typically vinyl chloride, and alkyl acrylates or methacrylates (e.g. methyl acrylate or methacrylate) and the blends thereof in different proportions. Generally a PVDC gas barrier layer will contain plasticisers and/or stabilizers as known in the art.

As used herein, the term “polyamide” refers to high molecular weight polymers having amide linkages along the molecular chain, and refers more specifically to synthetic polyamides such as nylons. Such term encompasses both homo-polyamides and co-(or ter-) polyamides. It also specifically includes aliphatic polyamides or co-polyamides, aromatic polyamides or co-polyamides, and partially aromatic polyamides or co-polyamides, modifications thereof and blends thereof. The homo-polyamides are derived from the polymerization of a single type of monomer comprising both the chemical functions which are typical of polyamides, i.e. amino and acid groups, such monomers being typically lactams or aminoacids, or from the polycondensation of two types of polyfunctional monomers, i.e. polyamines with polybasic acids. The co-, ter-, and multi-polyamides are derived from the copolymerization of precursor monomers of at least two (three or more) different polyamides. As an example in the preparation of the co-polyamides, two different lactams may be employed, or two types of polyamines and polyacids, or a lactam on one side and a polyamine and a polyacid on the other side.

Examples of “polyamides” include aliphatic homo- or co-polyamides commonly referred to as e.g. polyamide 6, polyamide 69, polyamide 610, polyamide 612, polyamide 11, polyamide 12, polyamide 6/12, polyamide 6/66, polyamide 66/610, modifications thereof and blends thereof. Said term also includes crystalline or partially crystalline, aromatic or partially aromatic, polyamides, such as polyamide 61/6T or polyamide MXD6.

The term “amorphous polyamide” is used herein to distinguish those polyamides and copolyamides with a relatively amorphous structure from those more conventional crystalline and semi-crystalline polyamides such as polyamide 6, polyamide 6/66 etc. which are also well known in the art. Some amorphous polyamides are copolyamides of an aliphatic hexamethylene diamide, and an aromatic isophthalic acid and terephthalic acid. Generally, amorphous polyamides can be characterized as high molecular weight polymers in which amide linkages occur, and contain aromatic segments with various proportions of aliphatic segments when produced as film grade resins. An example of an amorphous polyamide present on the market is Grivory G21 sold by EMS.

As used herein, the term “copolymer” refers to a polymer derived from two or more types of monomers, and includes terpolymers.

Ethylene/unsaturated ester copolymers are copolymers of ethylene and one or more unsaturated ester monomers. Useful ethylene/unsaturated ester copolymers are ethylene/vinyl acetate copolymers (EVA), copolymers of ethylene and alkyl esters of acrylic or methacrylic acid, where the esters have from 4 to 12 carbon atoms.

Useful propylene copolymers include propylene/ethylene copolymers (EPC), which are copolymers of propylene and ethylene having a majority weight percent content of propylene, and propylene/ethylene/butene terpolymers (EPB), which are copolymers of propylene, ethylene and 1-butene.

The term “polyesters” refers to polymers obtained by the polycondensation reaction of dicarboxylic acids with dihydroxy alcohols. Suitable dicarboxylic acids are, for instance, terephthalic acid, isophthalic acid, 2,6-naphthalene dicarboxylic acid and the like. Suitable dihydroxy alcohols are for instance ethylene glycol, diethylene glycol, 1,4-butanediol, 1,4-cyclohexanedimethanol and the like. Examples of useful polyesters include poly(ethylene 2,6-naphtalate), poly(ethylene terephthalate), and copolyesters obtained by reacting one or more dicarboxylic acids with one or more dihydroxy alcohols, such as PETG which is an amorphous co-polyesters of terephthalic acid with ethylene glycol and 1,4-cyclohexanedimethanol.

Unless otherwise stated, all the percentages are percentages by weight.

### DETAILED DESCRIPTION OF THE INVENTION

The Applicant has found out that films for VSP applications of certain thickness and mechanics, preferably comprising inner polyamide layer(s), show the correct balance of formability and toughness to allow a smooth skin packaging of very delicate products. Advantageously, the soft products so vacuum packaged do not protrude outside the sealing area and hence do not cause leakages and contamination.

A first object of the present invention is a vacuum skin package comprising a support, a soft product loaded onto said support and a top web draped over the product and welded to the part of the support not covered by the soft product, wherein the top web is a multilayer film, comprising at least an outer sealing layer a) and an outer abuse layer b), and wherein said multilayer film has an elastic modulus in LD of at least 3800 Kg/cm² measured at 23° C. according to ASTM D 882 and a total thickness lower than 100 microns.

The multilayer film may have a thickness lower than 90 microns, lower than 85 microns, lower than 80 microns, lower than 75 microns, lower than 70 microns. The multilayer film may have a thickness preferably lower than 85 microns. The multilayer film may have a thickness more preferably lower than 70 microns.

The films used in the VSP package according to the present invention show good mechanical properties, in particular very high values of elongation at break (%) as described in more detail in the experimental part.

The film for the present application is, preferably, characterized by one or more of the following mechanical properties:
a tensile strength in LD of at least 400 Kg/cm², and in TD of at least 325 Kg/cm² measured at 23° C. according to ASTM D 882, preferably a tensile strength in LD of at least 410 Kg/cm² or at least 420 Kg/cm². Preferably, the film has a tensile strength in TD of at least 334 Kg/cm²;
an elongation at break in LD of at least 580%, preferably of at least 640% and in TD of at least 600%, preferably at least 630% measured at 23° C. according to ASTM D 882;
an elastic modulus in LD of at least 3800 Kg/cm², preferably at least 4000 or 4060 Kg/cm² and/or in TD of at least 3670 Kg/cm², preferably at least 3900 Kg/cm² measured at 23° C. according to ASTM D 882.

Preferably, the film for the present use is further characterized by an elastic modulus in LD of at most 6000 Kg/cm², preferably of at most 5000 Kg/cm² measured at 23° C. according to ASTM D 882.

The film for the present application may have an elongation at break at 23° C., in longitudinal direction, of at least 300%, preferably at least 400%, and/or in transverse direction, of at least 300%.

The present film is preferably characterized by an elongation at break at 110° C., in longitudinal direction, of at least 900%, preferably at least 1100%, more preferably at least 1300% and/or in transverse direction, of at least 1500%, preferably at least 1800%, more preferably at least 2000%.

The present film is preferably characterized an implosion value greater than 5, preferably greater than 5.5, more preferably greater than 6, measured as described in the present experimental section. Preferably the present film is characterized by an implosion value lower than 6.6.

In the thin gauge version, e.g. 50 micron, the film for the use in the present invention shows excellent formability and good machinability, with no breaks as opposed to standard formulations.

The multilayer film for the present application includes at least an outer sealing layer a) and an outer abuse layer b).

The outer sealing layer a) of the present films comprises polymers generally used for this purpose in the art of VSP films, typically polyolefins characterized by very low Tg values. Suitable polymers for the heat-sealable layer may be ethylene homo- or co-polymers, like LDPE, ethylene/alpha-olefin copolymers, ethylene/acrylic acid copolymers, ethylene/methacrylic acid copolymers, or ethylene/vinyl acetate copolymers, ionomers, ethylene methacrylic acid (EMAA) and zinc salts thereof, polyethylene terephthalate and blends thereof. Preferred materials for the heat-sealable layer are LDPE, ethylene/alpha-olefin copolymers, ionomers, ethylene-vinyl acetate copolymers, ethylene methacrylic acid and zinc salts thereof, polyethylene terephthalate and blends thereof, more preferred ionomers, LDPE, ethylene/alpha-olefin copolymers, most preferred ionomers and LLDPE.

Preferred polymers for the sealing layer a) are for instance LD259 by ExxonMobil and Polybatch FSU 105E by Schulman and their blends or the polyesters Griltex ES 502 GF by EMS-Grivory, Eastobond 19412 by Eastman Chemical and their blend. The outer abuse layer b) is the layer of the film that will be in contact with the heated dome of the vacuum chamber in the VSP process. Outer layers b) in VSP applications typically comprise relatively high melting polyolefins, such ethylene homo-and co-polymers, propylene homo- and co-polymers, ionomers and (co)polyesters, i.e. PET-G, and their admixtures, preferably ionomers, MDPE and HDPE. Generally, suitable melting points are higher than 108° C., preferably higher than 110° C. or 120° C. In a preferred embodiment, the outer abuse layer b) may be HDPE. Suitable polymers include RIGIDEX HD6070FA by Ineos and Lumicene MPE M 6040 by Total Petrochemicals.

The top web multilayer film for the present application preferably includes at least an inner polyamide layer f).

Preferably, the film further comprises at least an inner polyamide layer f) in a percentage thickness ratio to the total thickness of the film of at least 3% and of at most 30%.

The at least one polyamide layer f) may comprise or not amorphous polyamides, preferably not.

Exemplary amorphous polyamides are Grivory G21 Natural di EMS-Grivory (PA 6I/6T) or Grivory HB5299 NATURAL by EMS-Grivory (PA-MXD6-MXDI).

The f) at least one polyamide layer, which preferably does not comprise amorphous polyamides, mainly comprises crystalline polyamides, generally in amount higher than 60% by weight of said layer composition, preferably higher than 80%, more preferably higher than 90%, even more preferably higher than 95%. Most preferably said polyamide layer f) consists of crystalline polyamides only.

With crystalline polyamides, a single crystalline polyamide or a blend or two or more crystalline polyamides is to be intended, preferably a single crystalline polyamide is intended.

The balance to 100% by weight of the composition of the f) at least one polyamide layer may be represented by suitable blendable thermoplastic materials or additives, such as for example an ionomer-nylon alloy produced by Du Pont and commercialized under the tradename of Surlyn AM7927, provided that amorphous polyamides are not included in these blends.

Crystalline polyamides are those polyamides whose melting point is preferably within the range from about 130 to 230° C., more preferably from about 160 to 220° C., even more preferably from about 185 to 210° C.

Crystalline polyamides comprise crystalline homo-polyamides and co-(or ter-) polyamides, preferably selected among PA6; PA6.6; PA6.66; PA66.6; PA6.12;

PA6.66.12; PA12; PA11; PA6.9; PA6.69; PA6.10; PA10.10; PA66.610; PA MXD6/MXDI, more preferably selected among PA6; PA6.66; PA6.12; PA6.66.12; PA12; PA11; PA6.9; PA MXD6/MXDI, even more preferably among PA6; PA6.66; PA6.12; PA6.66.12; PA12; PA11, even more preferably said crystalline polyamide being PA6.66, and blends thereof.

Crystalline polyamides are preferably selected within the polyamides listed above, more preferably within those polyamides listed above having melting points falling within the range preferably from about 140 to 230° C., more preferably from about 160 to 220° C., even more preferably from about 180 to 210° C. In the preferred embodiment, the polyamide is ULTRAMID C33 by BASF, having melting point of 196° C.

The thickness of f) the at least one polyamide layer is generally between 2 and 14 microns, preferably between 2 and 10, even more preferably between 2 and 4.

The percentage thickness ratio of f) the at least one polyamide layer, compared to the total thickness of the film, is at least 3%, at least 5%, at least 8%, preferable at least 10% but not more than 30%, preferably not more than 25%.

The total percentage by weight of polyamide in the whole film, when present, is preferably at least 5%, more preferably 8% or 10% and preferably at most 25%, more preferably at most 20% or 15%.

The multilayer film may also comprise at least one inner gas barrier layer e). The at least one inner gas barrier layer e) may be adhered to the at least one polyamide layer f), thus forming a multilayer core d).

The inner gas barrier layer e) generally comprises a material selected among PVDC, polyamides, EVOH, polyesters, and blends thereof, preferably EVOH, optionally blended with polyamides. The thickness of the inner gas barrier layer e) that is present in the overall structure will depend mainly on the overall thickness desired for the film. Said thickness can be expressed as a percentage of the total thickness of the present film, and it generally ranges between 5 and 25%, preferably between 10 and 20%, more preferably between 10 and 15% of the total thickness of the film. Suitable commercially available EVOH resins are SOARNOL AT4403 by Nippon Gohsei, EVAL G156B and EVAL F101B by EVALCA/Kuraray.

The gas barrier layer e) of the film used in the VSP package according to the present invention comprises PVDC, polyamides, such as MXD6/MXDI, EVOH, polyesters, and blends thereof, preferably EVOH, optionally blended with polyamides. The thickness of the e) gas barrier layer will be set in order to provide the overall multi-layer sheet with the optimal Oxygen Transmission Rate (OTR), lower than 500 cm³/m²·day·atm, preferably lower than 100, more preferably lower than 10, even more preferably lower than 7, when measured at 23° C. and 0% of relative humidity (evaluated by following the method described in ASTM D-3985 and using an OX-TRAN instrument by Mocon). Preferably, EVOH is used as the only component of the e) gas barrier layer.

Typically, when EVOH is employed as the only gas-barrier material, this is generally achieved with a thickness between 3 and 14, preferably between 4 and 12, more preferably between 5 and 10 microns. Thicker layers can be used if desired or if a lower OTR is needed. In some embodiments the gas barrier layer e) may be 5 microns, 6 microns, 7 microns, 8 microns, 9 microns, 10 microns, 11, microns, 11.2 microns, 12 microns, 13 microns, 14 microns. In a preferred embodiment, the e) gas barrier layer may be 7 microns.

The multilayer film may also comprise at least one inner bulk layer c). In some embodiments, the film may comprise two inner bulk layers, or even 3, 4 or 5 inner bulk layers.

The at least one inner bulk layer c) may be positioned on either side of a multilayer core d). The multilayer core d) may comprise at least a gas barrier layer e) and a polyamide layer f).

In some embodiments, the film comprise two inner bulk layers c) positioned on the opposite sides with respect to the d) multilayer core.

The at least one inner bulk layer c) or “structural” layer generally comprises polymers used to improve the abuse or puncture resistance of the film or just to provide the desired thickness. Polymers suitable for these layers are typically ethylene homo- and co-polymers, e.g. low density polyethylene, ethylene-vinyl acetate copolymers, linear low density polyethylenes, linear very low density polyethylenes and ionomers, preferably ionomers and ethylene-vinyl acetate copolymers, more preferably ethylene-vinyl acetate copolymers.

Preferably, the films for the use in the present invention comprise two bulk layers c) positioned on the opposite sides with respect to the d) multilayer core, said bulk layers comprising preferably the same polymers, more preferably ethylene-vinyl acetate copolymers. Suitable polymers are for examples ELVAX 3165 by DuPont and ESCORENE ULTRA FLO0119 by ExxonMobil.

The thickness of the bulk layer(s) c) that is present in the overall structure will depend mainly on the overall thickness desired for the film. Said thickness can be expressed as a percentage of the total thickness of the present film, and it generally ranges between 25 and 80%, preferably between 30 and 70%, more preferably between 35 and 60% of the total thickness of the film. In some embodiments, the thickness may be 42%.

The multilayer core d) of the films used in the VSP package of the present invention comprises e) a gas barrier layer and f) at least one polyamide layer adhered to the e) gas barrier layer.

The multilayer core d) of the film used in the VSP package according to the present invention comprises f) at least one polyamide layer adhered to the e) at least one inner gas barrier layer. Preferably the multilayer core d) comprises two polyamide layers f) adhered to the opposite surfaces of the at least one inner gas barrier layer e). The at least one or, preferably, two polyamide layers f), are preferably directly adhered to the at least one inner gas barrier layer e), i.e. without any interposed tie layer.

In a preferred embodiment comprising two polyamide layers f) directly adhered to the opposite surfaces of the inner gas barrier layer e), the thickness of each polyamide layer f) is generally between 1 and 7 microns, preferably between 1.5 and 6, even more preferably between 2 and 5. In some embodiments comprising two polyamide layers f) directly adhered to the opposite surfaces of the inner gas barrier layer e), the thickness of each polyamide layer f) may be 2.5 microns. In other embodiments comprising two polyamide layers f) directly adhered to the opposite surfaces of the inner gas barrier layer e), the thickness of each polyamide layer f) may be 3 microns. In further embodiments comprising two polyamide layers f) directly adhered to the opposite surfaces of the inner gas barrier layer e), the thickness of each polyamide layer f) may be 4 microns.

Other layers that may be optionally present in the multilayer film used in the VSP package according to the present invention are tie or adhesive layers g) that are employed to better adhere one layer to another in the overall structure. In particular, the film may include tie layer(s) g) directly adhered (i.e., directly adjacent) to one or both sides of the inner gas barrier layer e) and/or to one or both sides of polyamide layer(s) f) to better adhered to the polyamide layer(s) f) to the adjacent bulk layer(s) c). Additional tie layers may also be used to better adhere the bulk layer(s) c) to the adjacent sealing layer a) and/or outer abuse layer b).

Tie layers may include polymers having grafted polar groups so that the polymer is capable of covalently bonding to polar polymers such as EVOH or polyamides. Useful polymers for tie layers include ethylene-unsaturated acid copolymers, ethylene-unsaturated ester copolymers, anhydride-modified polyolefins, polyurethane, and mixtures thereof. Preferred polymers for tie layers g) include one or more of thermoplastic polymers such as ethylene-vinyl acetate copolymers with high vinyl acetate content (e.g. 18-28% or even more), ethylene-(meth) acrylic acid copolymers, ethylene homo-polymers or co-polymers, modified with anhydride or carboxylic acid functionalities, blends of these resins or blends of any of the above resins with an ethylene homo- or co-polymer, and the like known resins.

Tie layers are of a sufficient thickness to provide the adherence function, as is known in the art. Each tie layer may be of a substantially similar or of a different composition and/or thickness.

The multilayer film used in the VSP package according to the present invention may have any total thickness lower than 100 microns, preferably lower than 90 microns, so long as the film provides the desired properties (e.g. formability, abuse, puncture resistance, machinability, seal strength etc.) for the particular packaging application. For use as VSP top web, the film used in the VSP package according to the present invention has preferably a total thickness of from about 25 to about 100 microns, preferably from about 30 to about 90, more preferably from about 40 to about 90, even more preferably from about 45 to about 80. In some embodiments, for use as VSP top web, the film for the use in the present invention may have a total thickness lower than 90, 85, 80, 75 70, 60 microns. In other embodiments, for use as VSP top web, the film may have a total thickness of 50 microns. In further embodiments, for use as VSP top web, the film may have a total thickness of 70 microns. In yet further embodiments, for use as VSP top web, the film may have a total thickness of 80 microns.

The multilayer film may have a thickness preferably lower than 85 microns, more preferably lower than 70 microns.

The film used for the VSP package of the present invention may include any number of layers from 5 to 13, preferably from 7 to 11 layers and more preferably 9 layers. One or more of any of the layers of the multilayer film may include appropriate amounts of additives typically included in structures for food packaging for the desired effect, as it is known to those of skill in the packaging films art. For example, a layer may include additives such as slip agents, antiblock agents, antioxidants, fillers, dyes and pigments, cross-linking enhancers, cross-linking inhibitors, radiation stabilizers, oxygen scavengers, antistatic agents, and the like agents.

The films used in the VSP package according to the present invention are characterized by a resin layers sequence generally selected among: a/e/f/c/b, a/f/e/c/b, a/c/e/f/b, a/c/f/e/b (5 layers), a/f/e/f/c/b, a/c/f/e/f/b, a/c/e/f/c/b, a/c/f/e/c/b (6 layers), a/c/f/e/f/c/b (7 layers), a/c/c/f/e/f/c/c/b (9 layers), being preferred the sequences a/c/f/e/c/b, a/c/e/f/c/b, a/f/e/f/c/b, a/c/f/e/f/b, a/c/f/e/f/c/b, a/c/c/f/e/f/c/c/b, more preferred a/c/f/e/c/b, a/c/e/f/c/b, a/c/f/e/f/c/b, a/c/c/f/e/f/c/c/b, even more preferred a/c/f/e/f/c/b and a/c/c/f/e/f/c/c/b and all the possible combinations which result by introducing in said structures from 1 to 6 tie layers g), being the sequence a/c/g/f/e/f/g/c/b the most preferred.

Where the multilayer film representation above includes the same letter more than once, each occurrence of the letter may represent the same composition or a different composition within the class that performs a similar function.

In one embodiment, the film for the present does not comprise polyamides. Preferably, it comprises an inner gas barrier layer e), preferably made of EVOH. Preferably, it comprises two bulk layers c), one of each side of the gas barrier layer e).

In one embodiment, the multilayer top web used in the VSP package according to the present invention is a barrier film comprising a multilayer core d) composed of an inner gas barrier layer e) consisting of EVOH and two polyamide layers f) directly adhered to the gas barrier layer e).

In another embodiment, the film comprise four bulk layers c), with two bulk layers c) on each side of the multilayer core d). The bulk layers c) on each side of the multilayer core d) may be a first bulk layer c) of EVA and a second bulk layer c) of LLDPE-md.

In yet another embodiment, the multilayer core d) of the multilayer VSP barrier film comprises a gas barrier layer e) consisting of EVOH and two polyamide layers f) directly adhered to the opposite surfaces of the gas barrier layer e).

In one embodiment, the multilayer core d) comprises a gas barrier layer e) consisting of EVOH and two polyamide layers f) directly adhered to the opposite surfaces of the gas barrier layer e), the two polyamide layers f) consisting of crystalline polyamides.

In one embodiment, the multilayer core d)comprises a gas barrier layer e) consisting of EVOH and two polyamide layers f) directly adhered to the opposite surfaces of the gas barrier layer e), the two polyamide layers f) consisting of crystalline polyamides whose melting point is from 185 to 210° C.

In one embodiment, the multilayer core d) comprises a gas barrier layer e) consisting of EVOH and two polyamide layers f) directly adhered to the opposite surfaces of the gas barrier layer e), the two polyamide layers f) consisting of PA 6.66.

In another form of realization, the multilayer VSP barrier film comprises two inner bulk layers c) adhered to the opposite sides of the multilayer core d).

In one embodiment, the multilayer VSP barrier film comprises two inner bulk layers c) adhered to the opposite sides of the multilayer core d) by interposition of two tie layers g).

In one embodiment, the multilayer VSP barrier film comprises a multilayer core d) comprising
a gas barrier layer e) consisting of EVOH and
two polyamide layers f) directly adhered to the opposite surfaces of the gas barrier layer e), the two polyamide layers f) consisting of crystalline polyamides, and two inner bulk layers c) adhered to the opposite sides of the multilayer core d) by interposition of two tie layers g).

In one embodiment, the multilayer VSP barrier film comprises an outer sealing layer a) comprising ionomers or LDPE and an outer abuse layer b) comprising HDPE.

In one embodiment, the outer sealing layer a) comprises a material selected among

LDPE, ethylene/alpha-olefin copolymers, ionomers, ethylene-vinyl acetate copolymers and blends thereof, preferably among ionomers, LDPE, ethylene/alpha-olefin copolymers, more preferably between ionomers and LLDPE and b) outer abuse layer comprises a material selected among ionomers, MDPE and HDPE, being preferably HDPE.

The multilayer top web used in the VSP package according to the present invention can be made by any suitable extrusion or co-extrusion process, either through a flat or a round extrusion dies, preferably by round cast or by hot blown extrusion techniques. Suitable round or flat coextrusion lines for coextruding the films of the invention are well known in the art.

Preferably, for use as top web of a VSP package the film is non oriented.

The multilayer top webs used in the VSP package according to the present invention, or only one or more of the thermoplastic layers thereof, are preferably crosslinked.

Cross-linking is aimed at improving the strength of the film and/or helping to avoid burn through during heat seal operations and at increasing the heat resistance of the film that has to be brought in contact with the heated dome.

The preferred method of crosslinking is by electron-beam irradiation and is well known in the art. One skilled in the art can readily determine the radiation exposure level suitable for a particular application. Generally, however, radiation dosages of up to about 250 kGy are applied, typically between about 80 and about 240 kGy, with a preferred dosage of between 90 and 230 kGy, and a most preferred one between 110 and 220 kGy.

Irradiation is carried out conveniently at ambient temperature, although higher and lower temperatures, for example, from 0 to 60° C., may be employed.

Chemical cross-linking agents may also be employed to provide the necessary cross-linking of at least one of the component films of the film. Such agents are typically added to a resin directly or by means of a master batch prior to extrusion of the blend.

The package according to the present invention comprises a support.

Any support or bottom web generally suitable for VSP applications may also be used within the package of the present invention, including both in-line thermoformed and off-line pre-made supports. In some embodiments, the support comprises a thermoplastic material, preferably selected from polypropylenes, polyesters, PS or HDPE, and/or a non-thermoplastic material, preferably selected from cardboard or aluminium.

The support can be flat or shaped, e.g. a plate, a tray, a bowl, and may be rigid, semi-rigid or flexible. The support can be a pre-made support manufactured off-line before the packaging process or it can be made in-line by thermoforming during the packaging process.

Bottom web is typically a rigid or semi-rigid material or alternative a flexible material. The support generally comprises a thermoplastic material, preferably selected from polypropylenes, polyesters, PVC or HDPE, and/or a non-thermoplastic material, preferably selected from cardboard or aluminium.

Preferably, the bottom web is made of a multilayer material comprising, in addition to a heat-sealable layer to allow welding of the twin skin film to the part of the support not covered by the product, at least one bulk layer for the mechanical properties.

In a number of applications, the bottom web is required to have gas barrier properties, in particular oxygen barrier properties. Thus, in addition to a bulk and a heat-sealable layer, bottom web can advantageously I be provided with a gas barrier layer. The thickness of the gas barrier layer will be typically set in order to provide the support with an oxygen transmission rate lower than 30, lower than 15, preferably lower than 10 cm³/m²·d·atm (as measured according to ASTMD-3985 at 23° C. and 0% relative humidity).

Generally, the heat-sealable layer is selected among the polyolefins, such as ethylene homo- or co-polymers, propylene homo- or co-polymers, ethylene/vinyl acetate copolymers, ionomers. Suitable heat-sealable layers may also include peelable blends to provide the package with an easy-to-open feature.

Additional layers, such as tie layers, to better adhere the gas barrier layer to the adjacent layers, may be present in the bottom web material for the support and are preferably present depending in particular on the specific resins used for the gas barrier layer.

In case of a multilayer structure, part of it can be foamed and part can be cast. For instance, the bottom web may comprise (from the outermost layer to the innermost food-contact layer) one or more structural layers, typically of a material such as polystyrene, polyester, poly(vinyl chloride), polypropylene or cardboard; a gas barrier layer and a heat-sealable layer.

The overall thickness of the support will typically be up to 8 mm, preferably it will be comprised between 0.1 and 7 mm and more preferably between 0.2 and 6 mm. In some embodiments, the support may be a tray. Wherein the support is a tray, the support may have a total thickness lower than 1000 microns, than 800 microns, than 750 microns, than 700 microns. In a preferred embodiment, the support may be a tray and may have a total thickness lower than 750 microns.

A second object of the present invention is a VSP packaging process in which the top web is the film according to the first object of the present invention.

The VSP process comprises the steps of placing a support loaded with the product in a vacuum chamber, positioning the top web as previously defined above the product-loaded support, allowing the top web to drape itself over the product and to weld to the part of the support not covered by the product to obtain a vacuum skin package.

In more detail, the top web is fed to the upper section of a heated vacuum chamber comprising an upper and a lower section, and a vacuum is applied thereto from the outside, thereby drawing the skin-forming film into a concave form against the inwardly sloping walls of the upper section of the chamber and against the ports contained in the horizontal wall portion thereof (the top of the dome). Any conventional vacuum pump can be used to apply the vacuum and preferably, the skin-forming film is suitably pre-heated prior to the foregoing operation to render it more formable and thus better able to assume a concave shape in the upper section of the vacuum chamber. The product to be packaged is positioned on a support member, which can be flat or shaped, typically tray-shaped, and placed on a platform that is carried in the vacuum chamber, in the lower section thereof, just below the dome. The support member can be shaped off-line or, alternatively, in-line at an initial station on the vacuum packaging machine. Then the vacuum chamber is closed by moving the upper section down onto the lower one and during this whole sequence of operations vacuum is constantly applied to retain the concave shape of the film. Once the vacuum chamber is closed, vacuum is applied also in the lower section of the vacuum chamber in order to evacuate the space between the support member and the top skin-forming film. Vacuum in the upper section of the vacuum chamber continues to be applied to retain the concave shape of the skin-forming film until the area between the support and the skin-forming film is evacuated, then it is released and atmospheric pressure is admitted. This will collapse the softened top skin-forming film over the product and the support, as the atmosphere pushing the skin-forming film from the top and the vacuum pulling it from the bottom will cooperatively work to have the skin-forming film substantially conform to the shape of the product to be packaged on the support member. Optionally, after the evacuation step has been completed, a suitably selected purging gas or gas mixture could be flushed over the product to generate a very low residual gas pressure into the package. In some instances heat-sealing bars or other sealing means can be present in the vacuum chamber to carry out a perimeter heat-seal of the skin-forming film to the support member.

Preferred machines for carrying out the present VSP process according to the invention are supplied by Multivac, Mondini, Sealpac and Ulma.

A recently developed skin packaging process is described in WO2009141214, EP2722279, and EP2459448. In such process, the support used for the vacuum skin process is perforated in order to get a more efficient vacuum. Such process can be carried out by using, for instance, a machine named TRAVE E340, Trave 1000 Darfresh or Trave 590XL Darfresh by Mondini.

In a preferred variant of the present process, when performed on a Rollstock machine, the film before entering the vacuum chamber is pre-heated at a temperature lower than 130°, preferably lower than 120° C., preferably between 100 and 110° C.

A third object of the present invention is the use of a film as described under the first object of the present invention as a top web for vacuum packaging soft products, said film comprising at least an outer sealing layer a) and an outer abuse layer b), and being characterized by an elastic modulus in LD of at least 3800 Kg/cm², measured at 23° C. according to ASTM D 882, and by a total thickness lower than 100 microns.

Preferably, the film for use as the top web further comprises at least an inner polyamide layer f) in a percentage thickness ratio to the total thickness of the film of at least 3% and of at most 30%.

In the present vacuum skin package, process and use, the soft product may be selected from minced meat, ground meat, meat or fish hamburgers, caviar, sausages, sliced meat, sliced fish, sliced processed meat, diced meat, meat or fish tartare, paté, soft cheese, mashed vegetables, diced vegetables, mashed fruit, diced fruit, fresh dough, fresh fish, sauces, bread, pizza, pastries, fresh pasta and cooked pasta.

After the soft product has been packaged, the VSP package has no soft product protrusion from the flange of the package

### Examples

The present invention can be further understood by reference to the following examples that are merely illustrative and are not to be interpreted as a limitation of the scope of the present invention.

The films used for the packages of the inventions and the comparative films were manufactured through round cast coextrusion followed by crosslinking at 200 GYs.

Table 1 reports the list of resins and suppliers, Tables 2 to 4a-4b show the composition of the top web films.

TABLE 1

| TRADENAME | SUPPLIER | ACRONYM |
|---|---|---|
| Surlyn 1601 | DuPont | EMAA-Na1 |
| Surlyn 1702 | DuPont | EMAA-Zn1 |
| CONPOL 20S2 | DuPont | EMAA1 |
| NUCREL 1202 | DuPont | EMAA2 |
| ELVAX 3165 | DuPont | EVA1 |
| ESCORENE ULTRA FL00119 | ExxonMobil | EVA2 |
| ELVAX 3170 | DuPont | EVA3 |
| ELVALOY 741 | DuPont | EVA4 |
| OREVAC 18303 | Arkema | LLDPE-md1 |
| OREVAC 18300 | Arkema | LLDPE-md2 |
| ADMER NF518E | Mitsui Chemical | LLDPE-md3 |
| ADMER QB 520E | Mitsui Chemical | PP-md1 |
| SOARNOL AT4403 | Nippon Gohsei | EVOH1 |
| EVAL G156B | EVALCA/Kuraray | EVOH2 |
| EVAL F101B | EVALCA/Kuraray | EVOH3 |
| ULTRAMID C33 | BASF | PA-6\66 |
| LD259 | ExxonMobil | LDPE1 |
| POLYBATCH FSU 105E | Schulman | LDPE2 |
| LD158BW | ExxonMobil | LDPE3 |
| RIGIDEX HD6070FA | Ineos | HDPE1 |
| Lumicene MPE M 6040 | Total Petrochemicals | HDPE2 |
| CONSTAB AB 06051 LD | IMCD Italia spa | LLDPE1 |
| Polybutene-1 PB 8640M | Lyondell | PB1 |
| | Basell Industries | |
| Griltex ES 502 GF | EMS-Grivory | PET1 |
| Eastobond 19412 | Eastman Chemical | PET2 |

wherein

EMAA-Na1: Density 0.94 g/cm³, Melting point 96° C., Melt Flow Rate 1.30 g/10 min (190° C./2.16 kg).

EMAA-Zn1: Density 0.94 (g/cm³), Melt flow Rate 14 g/10 min (190° C./2.16 kg), Melting point 93° C.

EMAA1: Density 0.94 g/cm³, Melt Flow Rate 55 g/10 min (190° C./2.16 Kg), Melting point 95° C.

EMAA2: Comonomer content (methyacrylicAcid) 12%, Density 0.94 g/cm³, Melt flow rate 1.5 g/10 min (190° C./2.16 kg), melting point 99° C., Vicat softening point 75° C.

EVA1: Comonomer VA content 18%, Density 0.940 g/cm³, Melt Flow Rate 0.70 g/10 min (190° C./2.16 kg) Melting point 87.0° C., Vicat softening point 69.0° C.

EVA2: Comonomer VA content 19%, Density 0.942 g/cm³, Melt Flow Rate 0.650 g/10 min (190° C./2.16 kg), Melting point 85° C., Vicat softening point 62° C.

EVA3: Comonomer content VA 18%, Density 0.94 g/cm³, Melt Flow rate (190° C./2.16 Kg) 2.5 g/10 min, Melting point 90° C.

EVA4: Acid Number 35 mg/KOH/g, comonomer content (vinylacetate) 24%, Density 1.03 g/cm³, Melting point 66° C.

LLDPE-md1: Density 0.917 g/cm³, Melting point 124° C., Vicat softening point 87° C.

LLDPE-md2: Density 0.916 g/cm³, Melt Flow Rate 2.3 g/10 min (190° C./2.16 kg), Melting point 120° C., Vicat softening point 85° C.

LLDPE-md3 Density 0.91 g/cm³, Melt flow rate (190° C./02.16 kg) 3.1 g/10 min, Melting point 118° C.

PP-md1: Density 0.9 g/cm³, Melt flow rate (230° C./02.16 kg) 1.8 g/10 min, Melting point 161° C., Vicat softening point 140° C.

EVOH1: Comonomer (ethylene) content 44%, Crystallization point 144° C., Density 1.14 g/cm³, Melt Flow Rate 3.5 g/10min (210° C., 2160 g), Melting Point 164° C.

EVOH2: Comonomer (ethylene) content 48%, Density 1.12 g/cm³, Glass Transition 50° C., Melt Flow Rate 6.4 g/10 min (190° C./2.16 kg), Melting point 160° C.

EVOH3: Comonomer (ethylene) content 32%, Density 1.196 g/cm³, Melt Flow Rate 1.6 g/10 min (190° C./2.16 kg), Melting point 183° C., Vicat temperature 173° C. PA-6\66: Density 1.12 g/cm³, Melting point 196° C., Viscosity Relative min 3.19−max 3.41

LDPE1: Density 0.915 g/cm³, Melt Flow Rate 12 g/10 min (190° C./2.16 kg), Melting point 105° C.

LDPE2: Density 0.98 g/cm³, Melt Flow Rate 20 g/10 min (190° C./2.16 kg).

LDPE3: Density 0.925 g/cm³, Melt Flow Rate 2 g/10 min (190° C./2.16 kg), Melting point 111° C.

HDPE1: Density 0.96 g/cm³, Melt Flow Rate 7.6 g/10 min (190° C./2.16 kg), Melting point 132° C.

HDPE2: Density 0.96 g/cm³, Melt Flow Rate 4.0 g/10 min (190° C./2.16 kg), Melting point 134° C., Vicat Softening point 132° C.

LDPE1: Density 0.915 g/cm³, Melt Flow Rate 12 g/10 min (190° C./2.16 kg), Melting point 105° C.

PB1: Density 0.906 g/cm³, Melt flow rate (190° C./02.16 kg) 1 g/10 min, Melting point (Lyondell Basell method) 97° C.

PET1: Density 1.27 g/cm³, Glass Transition −11° C., Melting point 114° C., Viscosity 320 mPa·sec.

PET2: Density 1.33 g/cm³, Viscosity Intrinsic 0.74 dl/g.

TABLE 2

| | Film 1 | | Film 2 | | Film 3 | | Film 4 | |
|---|---|---|---|---|---|---|---|---|
| | | mic. | | mic. | | mic. | | mic. |
| 1 | EMAA- | 3 | EMAA- | 3 | LDPE1 | 3 | LDPE1 | 3 |
| | Zn1 98% | | Zn1 98% | | 98% | | 98% | |
| | EMAA1 | | EMAA1 | | LDPE2 | | LDPE2 | |
| | 2% | | 2% | | 2% | | 2% | |
| 2 | EVA1 | 7.5 | EVA2 | 7.5 | EVA2 | 7.5 | EVA2 | 7.5 |
| 3 | LLDPE- | 4.5 | LLDPE- | 4.5 | LLDPE- | 4.5 | LLDPE- | 4.5 |
| | md1 | | md2 | | md2 | | md2 | |
| 4 | PA-6\66 | 2.5 | PA-6/66 | 2.5 | PA-6/66 | 2.5 | PA-6/66 | 2.5 |
| 5 | EVOH1 | 7 | EVOH1 | 7 | EVOH1 | 7 | EVOH2 | 7 |
| 6 | PA-6/66 | 2.5 | PA-6/66 | 2.5 | PA-6/66 | 2.5 | PA-6/66 | 2.5 |
| 7 | LLDPE- | 4.5 | LLDPE- | 4.5 | LLDPE- | 4.5 | LLDPE- | 4.5 |
| | md1 | | md2 | | md2 | | md2 | |
| 8 | EVA1 | 13.5 | EVA2 | 13.5 | EVA2 | 13.5 | EVA2 | 13.5 |
| 9 | HDPE1 | 5 | HDPE1 | 5 | HDPE1 | 5 | HDPE1 | 5 |
| Tot | | 50 | | 50 | | 50 | | 50 |

mic. = thickness in microns

TABLE 3

| | Film 5 | | Film 6 | | Film 7 | | Comp. 1 | |
|---|---|---|---|---|---|---|---|---|
| | | mic | | mic | | mic | | mic |
| 1 | LDPE1 | 3 | PET1 60% | 6.4 | PET1 60% | 4 | EMAA- | 6 |
| | 98% | | PET2 40% | | PET2 40% | | Zn1 98% | |
| | LDPE2 | | | | | | EMAA1 | |
| | 2% | | | | | | 2% | |
| 2 | EVA2 | 7.5 | EVA2 | 21.6 | EVA2 | 13.5 | LDPE3 | 14 |
| 3 | LLDPE- | 4.5 | LLDPE- | 7.2 | LLDPE- | 4.5 | EVA1 | 19 |
| | md2 | | md2 | | md2 | | | |
| 4 | PA-6/66 | 2.5 | PA-6/66 | 4 | PA-6/66 | 2.5 | LLDPE- | 3 |
| | | | | | | | md2 | |
| 5 | EVOH2 | 7 | EVOH2 | 11.2 | EVOH2 | 7 | EVOH3 | 8 |
| 6 | PA-6/66 | 2.5 | PA-6/66 | 4 | PA-6/66 | 2.5 | LLDPE- | 3 |
| | | | | | | | md2 | |
| 7 | LLDPE- | 4.5 | LLDPE- | 7.2 | LLDPE- | 4.5 | EVA1 | 11 |
| | md2 | | md2 | | md2 | | | |
| 8 | EVA2 | 13.5 | EVA2 | 12 | EVA2 | 7.5 | LDPE3 | 26 |
| 9 | HDPE2 | 5 | HDPE1 | 6.4 | HDPE1 | 4 | HDPE1 | 10 |
| Tot | | 50 | | 80 | | 50 | | 100 |

TABLE 4a

| | Film 8 | | Comp. 2 | |
|---|---|---|---|---|
| | | mic. | | mic. |
| 1 | LDPE1 98% | 4 | EMAA-Zn1 | 7 |
| | LDPE2 2% | | 98% EMAA1 2% | |
| 2 | EVA3 | 3 | EVA3 | 4 |
| 3 | EMAA-Na1 | 10 | EVA1 | 23 |
| 4 | LLDPE-md2 | 2.5 | LLDPE-md2 | 3 |
| 5 | EVOH1 | 7 | EVOH1 | 12 |
| 6 | LLDPE-md2 | 2.5 | LLDPE-md2 | 3 |
| 7 | EMAA-Na1 | 16 | EVA1 | 38 |
| 8 | HDPE2 | 5 | HDPE1 | 10 |
| Tot. | | 50 | | 100 |

TABLE 4b

| | Film 9 | | Film 10 | | Film 11 | |
|---|---|---|---|---|---|---|
| | | mic | | mic | | mic |
| 1 | LDPE1 98% | 6 | LDPE1 98% | 6 | LDPE1 98% | 5 |
| | LDPE2 2% | | LDPE2 2% | | LDPE2 2% | |
| 2 | EVA3 | 4 | EVA3 | 4 | EVA2 | 13 |
| 3 | EMAA-Na1 | 15 | EMAA-Na1 | 15 | LLDPE-md2 | 6 |
| 4 | LLDPE- | 3 | LLDPE- | 3 | PA-6\66 | 2.5 |
| | md2 | | md2 | | | |
| 5 | EVOH1 | 9 | EVOH1 | 9 | EVOH1 | 9 |
| 6 | LLDPE- | 3 | LLDPE- | 3 | PA-6\66 | 2.5 |
| | md2 | | md2 | | | |
| 7 | EMAA-Na1 | 12 | EMAA-Na1 | 12 | LLDPE-md2 | 6 |
| 8 | EMAA-Na1 | 12 | EMAA-Na1 | 12 | EVA2 | 20 |
| 9 | HDPE2 | 6 | HDPE2 | 6 | HDPE2 | 6 |
| Tot | | 70 | | 70 | | 70 |

### Test Methods

The films prepared according to the examples, were submitted to specific tests with the aim to evaluate their main properties.

Tensile strength and Elongation at break at 23° C., measured according to ASTM D 882.

Tensile strength represents the maximum tensile load per unit area of the original cross-section of the test specimen required to break it, expressed as kg/cm².

Elongation at break represents the increase in length of the specimen, measured at break, expressed as percent of the original length.

Measurements were performed with Instron tensile tester equipped with a load cell type CM (1-50 kg), in an environmental chamber set at 23° C. on specimens of about 2, 54 cm (width)×20 cm (length), previously stored at 23° C. and 50% RH for minimum of 24 hours.

Six specimens were tested for each film in each sample direction. Tensile and elongation measurements were made simultaneously. The results, as average tensile strength at break and average elongation at break, are shown in Tables 5A-5C.

Tensile strength and Elongation at break at 110° C.

Testing general conditions were the same as above, but the following test set-up:
initial distance between the jags of the dynamometer was 1 cm,
crosshead speed was 1000 mm/min,
each specimen was kept at 110° C. for 10 minutes in an oven mounted around the jags before starting the test; the oven remained around the jags even during the test,
specimens were cut with the following dimensions: 12 cm long and 2.54 cm wide.

Measurements were performed with Instron tensile tester equipped with a load cell type CM (1-50 kg), in an environmental chamber set at 23° C. on specimens of about 2, 54 cm (width)×12 cm (length), previously stored at 23° C. and 50% RH for minimum of 24 hours.

Six specimens were tested for each film in each sample direction. Tensile and elongation measurements were made simultaneously. Results are reported as average tensile strength at break, and average elongation at break. Results are shown in Tables 5A-5C.

Oxygen Transmission Rate in dried conditions (in Tables 5A-5C abbreviated as OTR). The Oxygen Transmission Rate (OTR) was evaluated at 23° C. and 0% R.H. according to standard ASTM D-3985. The results, expressed as average OTR (cc/m²·day·atm), are reported in Tables 5A-5C.

Oxygen Transmission Rate in humid conditions (in Tables 5A-5C abbreviated as OTR). The present measurements were performed at 23° C., with samples with a humidity content of 100% (samples sandwiched between wet paper filters, put in a wet environment with relative humidity close to 100% for 4 days) on an oxygen permeability tester, equipped with 50 cm² diffusion cells, an oxygen-specific detector, relative humidity and temperature control system. The results, expressed as average OTR (cc/m²·day·atm), are reported in Tables 5A-5C.

Elastic modulus at 23° C.: it was evaluated following ASTM D 882. The average results of this test are reported in Tables 5A-5C.

Free shrink %: it was evaluated following ASTM D 2732 by immersion in hot oil kept at 160° C. The average results of this test for the film 10 are reported in Table 5C.

Haze: it was evaluated at 23° C. following ASTM D1003. The average results of this test are reported in Tables 5A-5C.

Gloss 60°: it was evaluated following ASTM D2457. The average value of the measurements performed in longitudinal and transverse direction was reported. The average results of this test are reported in Tables 5A-5C.

Clarity: it was evaluated at 23° C. following ASTM D1003. The average results of this test are reported in Table 5C.

The results of the above tests for the films 9 to 11 are shown in Table 5C.

TABLE 5A
physical properties of the top films

| | | Film n. | | | | | | |
|---|---|---|---|---|---|---|---|---|
| property | units | 2 | 3 | 4 | 5 | 6 | 7 | 8 |
| gloss | g.u. | 129 | 96 | 95 | 90 | 88 | 97 | 87 |
| haze | % | 4 | 6.7 | 7 | 8.8 | 33.3 | 5.8 | 35 |
| OTR 0% | cc/m² day | 7.8 | 7.4 | 17 | 18 | 15 | 10 | 16 |
| RH 23° C. | | | | | | | | |
| OTR 100% | cc/m² day | 160 | 150 | 110 | 120 | 73 | 130 | 110 |
| RH 23° C. | | | | | | | | |
| tensile at | Kg/cm² | 484 | 452 | 493 | 477 | 446 | 384 | 491 |
| 23° C. LD | | | | | | | | |
| tensile at | Kg/cm² | 373 | 363 | 383 | 334 | 353 | 334 | 363 |
| 23° C. TD | | | | | | | | |
| elongation at | % | 640 | 650 | 670 | 670 | 700 | 580 | 650 |
| 23° C. LD | | | | | | | | |
| elongation at | % | 650 | 650 | 710 | 630 | 670 | 620 | 660 |
| 23° C. TD | | | | | | | | |
| modulus at | Kg/cm² | 4650 | 4610 | 4080 | 4060 | 3800 | 4250 | 4160 |
| 23° C. LD | | | | | | | | |
| modulus at | Kg/cm² | 4440 | 4530 | 4060 | 3930 | 3670 | 4390 | 3950 |
| 23° C. TD | | | | | | | | |
| tensile at | Kg/cm² | 170 | n.a. | n.a. | n.a. | n.a. | 92.6 | n.a. |
| 110° C. LD | | | | | | | | |
| tensile at | Kg/cm² | 125 | n.a. | n.a. | n.a. | n.a. | 70 | n.a. |
| 110° C. TD | | | | | | | | |
| elongation at | % | 1800 | n.a. | n.a. | n.a. | n.a. | 1200 | n.a. |
| 110° C. LD | | | | | | | | |
| elongation at | % | 2000 | n.a. | n.a. | n.a. | n.a. | 1600 | n.a. |
| 110° C. TD | | | | | | | | |

TABLE 5B
physical properties of the top films

| | | Film n. | | |
|---|---|---|---|---|
| property | units | 1 | C2 | C1 |
| gloss | g.u. | 130 | 130 | 120 |
| haze | % | 4 | 5 | 9 |
| OTR 0% RH, 23° C. | cc/m²*day | 11 | 6 | 1,3 |
| OTR 100% RH, 23° C. | cc/m²*day | 150 | 80 | 235 |
| tensile at 23° C. LD | Kg/cm² | 430 | 350 | 330 |
| tensile at 23° C. TD | Kg/cm² | 325 | 250 | 240 |
| elongation at 23° C. LD | % | 580 | 650 | 630 |
| elongation at 23° C. TD | % | 600 | 700 | 650 |
| modulus at 23° C. LD | Kg/cm² | 4150 | 3300 | 4200 |
| modulus at 23° C. TD | Kg/cm² | 4150 | 3200 | 4300 |
| tensile at 110° C. LD | Kg/cm² | | 57 | 66 |
| tensile at 110° C. TD | Kg/cm² | | 52 | 43 |
| elongation at 110° C. LD | % | | 700 | 590 |
| elongation at 110° C. TD | % | | 2300 | 2200 |

TABLE 5C
physical properties of the top films

| | | Film n. | | |
|---|---|---|---|---|
| property | units | 9 | 10 | 11 |
| gloss | g.u. | | | |
| haze | % | 6 | 7 | 6 |
| clarity | % | 89 | 87 | 90 |
| tensile at 23° C. LD | Kg/cm² | 370 | 400 | 420 |
| tensile at 23° C. TD | Kg/cm² | 360 | 360 | 330 |
| elongation at 23° C. LD | % | 550 | 590 | 630 |
| elongation at 23° C. TD | % | 580 | 620 | 610 |
| modulus at 23° C. LD | Kg/cm² | 4000 | 4100 | 3800 |
| modulus at 23° C. TD | Kg/cm² | 2900 | 4100 | 3900 |
| free shrink at 160° C. LD | % | | 9 | |
| free shrink at 160° C. TD | % | | −4 | |

### Packaging Test (I) on Darfresh on Tray® Machine

Vacuum skin packages of minced meat (stored at 6° C.), by using films 1 to 8 and comparative films C1 and C2 as top webs and a tray, were manufactured by using a skin packaging machine Mondini TRAVE E340 VG at various dome temperature settings from 160° C. to 230° C. An internal sensor in the skin-packaging machine, generally used to set the temperature of the heated dome, was also used to record the sealing temperature.

Two trays were used for the tests.

For top films 1 to 5, 8, C1 and C2 the tray was EOST 1826-13 by Cryovac, a rectangular tray 18×26 (width×length) and 13 mm deep, with a total thickness of 750 mic. and it was thermoformed offline. Such a tray was composed of a polypropylene monolayer of about 700 mic. laminated with a multilayer film easy open liner (Lined, 43 mic. thick, the composition is disclosed in Table 4a).

For top films 6 and 7, Linpac tray code R15-13SW VSP, 750 mic. thick was used. This tray is an unfoamed mono-PET material without liner, having a thickness at flange of 600 microns and 18×26 (width×length) and 13 mm deep.

The machine operated at 6.4 cycles/min with a vacuum lower than 15 mbar. The packaging machine perforated the support (4 holes, dimension: 3 mm×6 mm, hole shape: oval) to allow a more efficient vacuum phase.

The dome height was 25 mm, the vacuum time was from to 2.0 to 3.0 seconds. Thirty packages were manufactured for each sample and for each temperature. The packaged product was a portion of 400 g of minced meat: The meat was placed in the center of the tray covering about 80% of the available area for a product height of about 30-33 mm.

All the packages prepared during the testing, were manually opened by two panellists and the sealability of the packages was judged. The sealability was evaluated as good from both panellists for all the webs. In addition, for the packages including the films 1 to 8 also the appearance was considered to be excellent. The minced meat was not squeezed or deformed when using films 1 to 8, while when using the comparative films C1 and C2 the meat was highly deformed and squeezed in the final package. Machinability was judged as good for all the films.

The packages obtained with film 3 further provided the advantage of significantly reducing the meat sticking to the top when opening the package. This was due, according to the inventor, to the selection of the sealing layer.

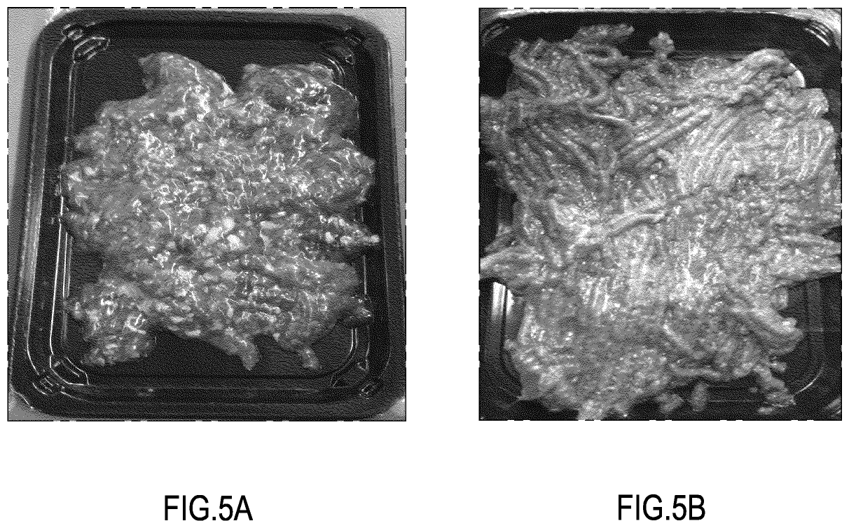

Other vacuum skin packages of minced meat were manufactured and reported in the pictures of FIG. 5A and FIG. 5B.

In particular, the package of FIG. 5A was prepared with a Mondini TRAVE E340 VG.

The top film was comparative film C2 and tray was EOST 1826-13 by Cryovac. The packaging conditions and the tray details are reported above.

The dome temperature was 200° C. and the minced meat temperature, measured just before packaging, was 6° C.

The package of FIG. 5B was prepared with a Mondini TRAVE E340 VG. The top film was film 1 and tray was EOST 1826-13 by Cryovac. The packaging conditions and the tray details are reported above.

The dome temperature was 200° C. and the minced meat temperature, measured just before packaging, was 6° C.

As clearly visible from FIG. 5A, the minced meat appearance is poor, the typical filaments of meat, resulting from the mincing process, are no more visible as the meat was completely squeezed by comparative film C2. On the contrary, in the package of FIG. 5B, those filaments can be clearly seen as the meat is not squeezed.

In conclusion, the films for the use of the present invention advantageously allow the manufacture of appealing minced meat packages without recurring to the troublesome method of “crust-freezing”.

### Packaging Test (II) on Darfresh on Tray® Machine

Vacuum skin packages of minced meat (stored at 6° C.), by using the films 9 to 11 as top web and a tray, were manufactured on a skin packaging machine Mondini

TRAVE E590 VG at various dome temperature settings from 180° C. to 210° C. An internal sensor in the skin-packaging machine, generally used to set the temperature of the heated dome, was also used to record the sealing temperature.

The tray used for the test was a rectangular tray R13-13SS, 13 mm deep (Linpac), with a total thickness of 600 mic, thermoformed offline. The tray was made of PET with a liner.

The machine operated at 6.4 cycles/min with a vacuum lower than 15 mbar. The packaging machine perforated the support (4 holes, dimension: 3 mm×6 mm, hole shape: oval) to allow a more efficient vacuum phase.

The dome height was 40 mm, the vacuum time was from to 2.0 to 3.0 seconds. Thirty packages were manufactured for each film sample and for each temperature. The packaged product was a portion of 400 g of minced meat. The meat was placed in the centre of the tray covering about 80% of the available area for a product height of about 30-33 mm.

All the packages prepared during the testing, were manually opened by two panellists and the sealability of the packages was judged.

The sealability was evaluated to be good from both panellists for all the tested films. In addition, also the appearance was considered to be excellent. The minced meat was not squeezed or deformed. Finally, the machinability of all the tested films was satisfying.

### Packaging Test on Rollstock Machine

The vacuum skin packages were manufactured on a skin-packaging machine (Multivac R570CD) at the dome temperature of 180° C. to 210° C. An internal sensor in the skin-packaging machine, that is used to set the temperature of the heated dome, was used to record the sealing temperature. The equipment had a dome height of 50 mm and vacuum time was set to 1 sec. The bottom film was thermoformed inline, with bottom dimensions of 250 mm long×142 mm wide×5 mm deep.

Films 1 to 8 and comparative C1 and C2 (top webs) were pre-heated at a temperature of about 110° C., were sealed onto an APET EGA010 tray, 250 microns thick (APET 200 microns/PE 50 microns, polyethylene sealant liner). The bottom web was used with the APET layer facing the sealant layer of the top web. The APET was an amorphous PET having a Tg of about 78° C.

Thirty packages were manufacture for each tested top film and temperature. The packaged product was a portion of about 300 g of minced meat, stored at 6° C. All the packages prepared during the testing, were manually opened by two panellists and the sealability of the packages was judged to be good for all the films tested.

In addition, the packages including the films 1 to 8 also had an excellent appearance. The minced meat was not squeezed or deformed, when using films 1 to 8 while, with the comparative films C1 and C2, the meat was highly deformed and squeezed in the final package. Machinability was judged to be good for all the films. As above, the packages obtained with film 3 further provided the advantage of significantly reducing the meat sticking to the top when opening the package. This was due, according to the inventor, to the selection of the sealing layer.

TABLE 6
Liner 1 composition

| Layer | Thickness microns | Liner 1 |
|---|---|---|
| 1 | 2.0 | LDPE1 50% |
| | | EMAA2 49% |
| | | LLDPE1 1% |
| 2 | 6.0 | PB1 20% |
| | | EVA4 22% |
| | | EMAA-Na1 58% |
| 3 | 9.0 | LLDPE-md3 |
| 4 | 6.0 | EVOH1 |
| 5 | 20.0 | PP-md1 |
| Total | 43.0 | |

### Formability Test

This method is used to measure the ability of a VSP top web to be formed over a product. It consists of a standard packaging procedure followed by the assignment of a score from 0 to 3 based on the recurrence of sealing defects, in particular on the incidence of bridging, webbing and pleats formation during VSP packaging. For the formability test, a conventional VSP cycle was performed using the Darfresh on Tray machine TRAVE E340 VG, dome 25 mm, dome temperature 180° C. Additional testing was performed on a Rollstock machine, Multivac R570CD® with a dome of 50 mm, preheating at 110° C., dome temperature of 210° C. and the other settings as specified before.

The products packaged were parallelepiped (105 mm wide×190 mm long×30 mm high) or circular (diameter 105 mm, height 28 mm) shaped plastics blocks.

The tray used in combination with each film were the same specified above for the packaging test.

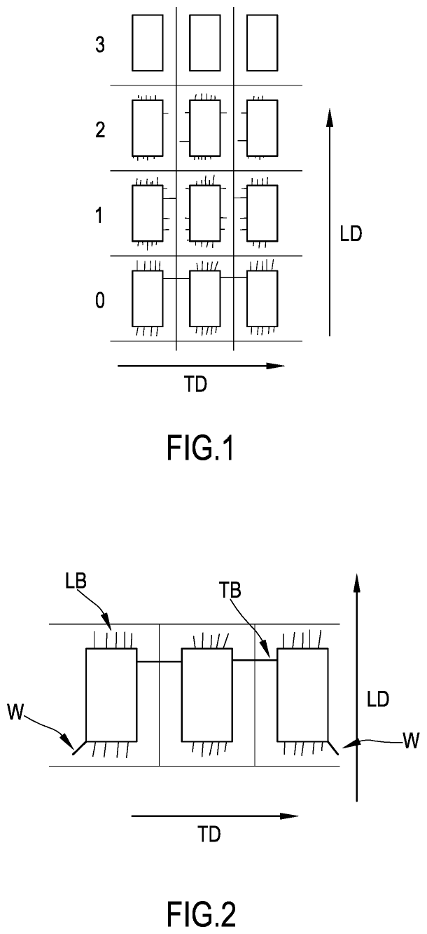

For each kind of package, fifteen packages were manufactured and scored by two panelists for webbing (pleats located in the corner) and for bridging. A rating of 3 was the best score (no webbing and no bridging) and a rating of 0 was the worst score. FIGS. 1 and 2 illustrate the sealing defects evaluated for the score, in particular W (webbing), LB (longitudinal bridging) and TB (transverse bridging). FIG. 3 illustrates the sealing defect for circular bridging (CB). The average result of the evaluation for the films for the use of the present invention 2 to 8 and for reference films C1 and C2 are reported in Tables 7 and 8 below.

### Implosion Resistance Test on Films 2 to 7, C1 and C2 (I)

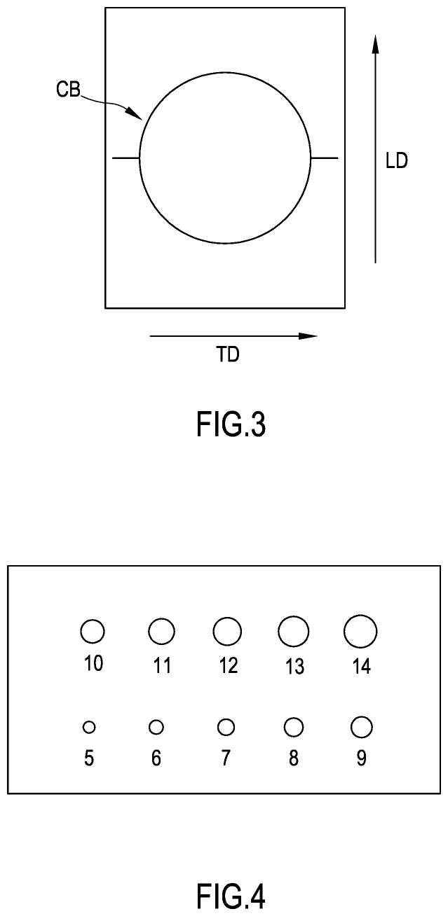

The implosion resistance test was used to measure the ability of a VSP film to fill cavities without breaking. A conventional VSP cycle was performed, as described earlier for the formability test, but the articles packaged were plastic blocks (100 mm wide×190 mm long×25 mm high) having, on the top surface, 10 calibrated holes having the same depth (20 mm) but of different diameters. The diameter of the holes ranges from 5 to 14 mm as illustrated in FIG. 4.

For the implosion test on Rollstock machine Multivac R570CD, a reduction of the re-venting nozzle diameter was applied through a screwed insert: the final diameter of the nozzle was 7 mm instead of 25 mm in order to allow for a slower draping of the film onto the support and the testing block, while for the implosion test on On Darfresh on Tray machine TRAVE E340 VG the re-venting nozzle was fully open. During the packaging tests with the plastic block, the film tends to undergo a stretching stress at the holes, which increases with the area of the hole. The diameter of the largest hole, before the film broke, was taken as index of implosion resistance and as a score for the packaging performance of the film. Top films suitable for the present use usually have an implosion resistance index of at least 5.7 or more. Two panelists evaluated films performance in terms of implosion resistance on 30 samples for each type of VSP package (30 packages for each combination of top and bottom) and the average value was calculated and reported in Table 7.

Table 7 shows the outcome of the test carried out on a Darfresh on tray machine with a 25 mm dome, and a dome temperature of 180° C.

### Table 7

Formability and Implosion of Top
Webs on Darfresh on Tray equipment

| | | Bridging | | | |
|---|---|---|---|---|---|
| Film | Webbing | BT | BL | BC | Implosion |
| 2 | 3.0 | 3.0 | 3.0 | 2.0 | 6.4 |
| 3 | 3.0 | 2.0 | 2.0 | 2.0 | 6.3 |
| 4 | 3.0 | 2.8 | 3.0 | 2.0 | 6.0 |
| 5 | 3.0 | 2.6 | 3.0 | 2.2 | 6.4 |
| 6 | 3.0 | 2.7 | 3.0 | 2.5 | 7.5 |
| 7 | 2.0 | 2.2 | 3.0 | 2.0 | 6.4 |

Table 8 gives the average values for the comparative films C2 and C1 formability evaluated on a Rollstock machine, Multivac R570CD® and on a Darfresh on tray Mondini machine, TRAVE E340 VG.

TABLE 8
Formability and Implosion of Comparative Top Webs

| | | | Bridging | | | |
|---|---|---|---|---|---|---|
| Film | Equipment | Webbing | BT | BL | BC | Implosion |
| C2 | Rollstock | 2.7 | 2.9 | 3.0 | 2.9 | 11.0 |
| C2 | Darfresh | 3.0 | 3.0 | 3.0 | 3.0 | 7.9 |
| | on Tray | | | | | |
| C1 | Rollstock | 2.4 | 2.6 | 2.6 | 1.6 | 8.6 |
| C1 | Darfresh | 3.0 | 3.0 | 3.0 | 3.0 | 6.6 |
| | on Tray | | | | | |

Table 7 shows that all samples had a webbing score of 3.0, except for Film 7 for which the value (2.0) was in any case acceptable. Film 6 had the overall highest bridging score with an average of 2.7 and had the highest implosion value of 7.5.

Both Film 2 and Film 6 had very high score for webbing and bridging, thus demonstrating to be highly formable.

As can be seen from the values above, Film 2 had a formability very similar to Film 6 and the same implosion value, despite having a thickness of 50 mic, whereas Film 6 had a thickness of 80 mic. Furthermore, all samples in Table 7 had good values for formability and implosion notwithstanding Film 2-Film 5 and Film 7 all had a low thickness of 50 mic. and Film 6 had a thickness of 80 mic. The performance of the films for use in the present invention was comparable (Table 8) with the comparative films C2 and C1 both having a thickness of 100 mic.

In conclusion, the films selected for the present use have very good formability and implosion scores with a much thinner top film formulation.

### Implosion Resistance Test on Films 9 to 11 (II)

Another implosion resistance test was carried out on the films 9 to 11 according to the following slightly different conditions.

Darfresh on tray TRAVE E340 VG was equipped with a 25 mm dome and the dome temperature was 200° C. and the tray used was 1826SW-13SP by Cryovac (polypropylene bulk with polyethylene-based liner). The machine operated at 6.4 cycles/min with a vacuum lower than15 mbar. The packaging machine perforated the support (4 holes, dimension: 3×6 mm², hole shape oval) to allow a more efficient vacuum phase. The dome height was 25 mm, the vacuum time was from to 2.0 to 3.0 seconds.

The dome temperature for the implosion test on Rollstock Multivac R570CD was 210° C. and the dome height was 50 mm. The bottom film was thermoformed inline, (bottom dimensions: 250 mm long×142 mm wide×5 mm deep). The films (9 to 11) were pre-heated at a temperature of about 110° C. and they were sealed onto an APET EGA010 250 microns tray (APET 200 microns/PE 50 microns, polyethylene sealant liner). The bottom web was used with the APET layer facing the sealant layer of the top web. The APET was an amorphous PET having a Tg of about 78° C. Two panelists evaluated films performance in terms of implosion resistance on 30 samples for each type of VSP package (30 packages for each combination of top and bottom) and the average value was calculated and reported in Table 9. Table 9 provides the average implosion values for the films 9 to 11 on Rollstock machine and on Darfresh on tray Mondini machine TRAVE E340 VG.

TABLE 9

| | Implosion | Implosion |
|---|---|---|
| Film | Darfresh on Tray | Rollstock |
| 9 | 6.6 | 8.3 |
| 10 | 5.7 | 8.1 |
| 11 | 6.6 | 9.7 |

1) A vacuum skin package comprising a support, a soft product loaded onto said support and a top web draped over the product and welded to the part of the support not covered by the soft product, wherein the top web is a multilayer film comprising at least an outer sealing layer and an outer abuse layer and wherein said multilayer film has an elastic modulus in LD of at least 3800 Kg/cm² measured at 23° C. according to ASTM D 882 and a total thickness lower than 100 microns.

2) The package according to claim 1 wherein the film further comprises at least an inner polyamide layer in a percentage thickness ratio to the total thickness of the film of at least 3% and of at most 30%.

3) The package according to claim 1 wherein the of total thickness of the film is lower than 90 microns.

4) The package according to claim 1 wherein the film has a tensile strength in LD of at least 400 Kg/cm² or at least 410 Kg/cm² or at least 420 Kg/cm² measured at 23° C. according to ASTM D 882.

5) The package according to claim 1 wherein the film is further characterized by an elongation at break in LD of at least 580% measured at 23° C. according to ASTM D 882.

6) (canceled)

7) The package according claim 1 wherein the film further comprises an inner gas barrier layer.

8) (canceled)

9) The package according to claim 1 wherein the film comprises at least an inner polyamide layer and the total percentage by weight of polyamide in the whole film is at least 5% and at most 25%.

10) The package according to claim 1 wherein the film comprises at least an inner polyamide layer that comprises at least a crystalline polyamide selected from PA6, PA6.6, PA6.66, PA66.6, PA6.12, PA6.66.12, PA12, PA11, PA6.9, PA6.69, PA6.10, PA10.10, PA66.610, PA MXD6/MXDI and their blends.

11) (canceled)

12) The package according to claim 9 wherein said at least an inner polyamide layer comprises crystalline polyamides having a melting point from 130 to 230° C. in amount higher than 60% by weight in respect of said layer weight.

13) The package according to claim 9 where the at least one polyamide layer does not comprise amorphous polyamides.

14) (canceled)

15) The package according to claim 9 wherein the film further comprises at least one gas barrier layer adhered to the at least one polyamide layer, said adhered layers and forming a multilayer core the at least one inner gas barrier layer comprises a polymer selected from PVDC, polyamides, EVOH, polyesters or blends thereof.

16) (canceled)

17) The package according to claim 15 in which the multilayer core of the film comprises two polyamide layers adhered to the opposite surfaces of the gas barrier layer.

18) (canceled)

19) The package according to claim 15 where the film comprises two inner bulk layers positioned on the opposite sides with respect to a multilayer core wherein the thickness of the at least one inner bulk layer of the film or the total thickness of the two inner bulk layers c) is from 30 to 80%.

20) (canceled)

21) The package according to claim 19 where the at least one inner bulk layer comprises a polymer selected from low density polyethylene, ethylene-vinyl acetate copolymers, linear low density polyethylenes, linear very low density polyethylenes and ionomers.

22) The package according to claim 1 in which the outer sealing layer of the film comprises a polymer selected from LDPE, ethylene/alpha-olefin copolymers, ionomers, ethylene-vinyl acetate copolymers, ethylene methacrylic acid and zinc salts thereof, polyethylene terephthalate and blends thereof, and the outer abuse layer comprises a polymer selected from ionomers, MDPE and HDPE.

23) The package according to claim 1 wherein the film is cross-linked.

24) The package according to claim 1 wherein the film has an elastic modulus in LD of at most 6000 Kg/cm².

25) (canceled)

26) The package according to claim 1 wherein the support comprises a thermoplastic material selected from polypropylenes, polyesters, PVC or HDPE, and/or a non-thermoplastic material.

27) A vacuum skin packaging process, for the manufacture of a vacuum skin package of a soft product, which comprises:
providing a top web,
providing a support,
disposing the top web over the support,
disposing the soft product onto the support,
heating the top web and molding it down upon and around the soft product and against the support, the space between the heated top web and the support having been evacuated, to form a tight skin around the soft product, and
tight sealing said top web over the entire surface of the support not covered by the product by differential air pressure, thus providing a vacuum skin package,
wherein the top web is a multilayer film, comprising at least an outer sealing layer, an outer abuse layer and, optionally, at least an inner polyamide layer in a percentage thickness ratio to the total thickness of the film of at least 3% and of at most 30%, and wherein said multilayer film has an elastic modulus in LD of at least 3800 Kg/cm² measured at 23° C. according to ASTM D 882 and a total thickness lower than 100 microns.

28) Use of a multilayer film comprising at least an outer sealing layer, an outer abuse layer and optionally an inner polyamide layer in a percentage thickness ratio to the total thickness of the film of at least 3% and of at most 30%, as top web for vacuum skin packaging soft products, wherein the film has an elastic modulus in LD of at least 3800 Kg/cm² measured at 23° C. according to ASTM D 882 and a total thickness lower than 100 microns.

29) (canceled)
